(19) United States
(12) Patent Application Publication
(10) Pub. No.: US 2010/0031260 A1
(43) Pub. Date: Feb. 4, 2010

(54) Object-Oriented Thread Abort Mechanism for Real Time C++ Software

(75) Inventor: Laszlo Istvan Morocz, Glenn Dale, MD (US)

Correspondence Address: Lockheed Martin c/o;DEMONT & BREYER, LLC, 100 COMMONS WAY, Ste. 250, HOLMDEL, NJ, 07733, US

(73) Assignee: LOCKHEED MARTIN CORPORATION, Bethesda, MD (US)

(21) Appl. No.: 12/182,622

(22) Filed: Jul. 30, 2008

(51) Int. Cl. G06F 9/46

(52) U.S. Cl. 718/100

(57) ABSTRACT

A method and architecture are disclosed for gracefully handling aborted threads in object-oriented systems. In accordance with the illustrative embodiment, a platform adaptation software layer intercepts calls from an application to the operating system and checks for a request to abort a thread. When such a request is detected, the platform adaptation software layer throws an exception and allows the intercepted call to reach its destination (i.e., the operating system). When the exception is caught at the application layer, the appropriate object instances' destructors can be invoked, and resources associated with the thread can be released and cleaned up.

### STATEMENT REGARDING FEDERALLY-SPONSORED RESEARCH

This invention was made with Government support under W31P4Q-04-C-0059 awarded by the Department of the Army. The Government has certain rights in the invention.

### FIELD OF THE INVENTION

The present invention relates to computer software in general, and, more particularly, to aborting threads in object-oriented software systems.

### BACKGROUND OF THE INVENTION

A thread is a single sequential flow of control within a program. Threads are sometimes referred to as lightweight processes because they execute within the context of a full-blown program and take advantage of the resources allocated for that program and the program's environment. As a sequential flow of control, a thread must carve out some of its own resources within a running program (e.g., its own execution stack, program counter, etc.)

When a program creates a thread and initiates its execution, the thread is said to be spawned by the program. A multi-threaded program can spawn multiple threads that execute simultaneously and asynchronously, a technique that is particularly well-suited to real-time software systems.

Sometimes it is necessary to abort the execution of a thread (e.g., for convenience, for safety, etc.), in which case the problem arises of releasing and cleaning up the resources associated with the thread. One such technique for handling aborted threads is to employ software routines called cancellation points that, in addition to their normal functions, check whether a thread has been designated to abort, and if so, invoke a thread abort mechanism.

When a thread is aborted at a cancellation point, the cancellation points do not take care of releasing and cleaning up a thread's resources after the thread has been aborted, and thus some additional mechanism is needed to perform these functions. One such mechanism, called cleanup blocks, is defined in the Institute of Electrical and Electronics Engineers (IEEE) Portable Operating System Interface (POSIX) standard.

### SUMMARY OF THE INVENTION

The present invention is based on the observation that mechanisms of the prior art for releasing and cleaning up resources of aborted threads are not well-suited for object-oriented software systems (e.g., software written in the C++ programming language, the Java programming language, etc). In particular, methods of the prior art, such as cleanup blocks, do not handle class variables' destructors well, or clean up dynamically-allocated resources, or handle the clearing of software locks. Consequently, aborting a thread in an object-oriented system in accordance with the prior art is a risky business that can leave a system in an indeterminate and unsafe state.

Cleanup blocks of the prior art also suffer from a number of other disadvantages. First, cleanup blocks are an unnatural construct in object-oriented programming languages such as C++, and might not be intuitive to software engineers in the object-oriented programming world. Second, cleanup blocks are scope-limited; that is, they must be released in the same syntactic block in which they were saved. This prevents cleanup blocks from being saved in a constructor and released in a destructor, as is normal in C++ and other object-oriented programming languages. Third, cleanup blocks are unable to handle some standard constructs of object-oriented programming languages, such as C++ automatic class variables.

The mechanism of the present invention, in contrast, does not suffer from any of the aforementioned disadvantages. In particular:
it is inherently object-oriented;
there are no scope-related issues, because the mechanism only signals that a thread has been aborted, rather than attempting to release and clean up resources;
the thread itself uses its own existing cleanup routines whenever and wherever it is appropriate to do so;
there are no limitations on which programming language features or constructs can be used; and
because the aborted thread is handled with standard exception processing, the mechanism can be easily incorporated into many existing applications.

In accordance with the illustrative embodiment of the present invention, a platform adaptation software layer intercepts calls from the application layer to the operating system (OS) and checks for a request to abort a thread. When such a request is detected, the platform adaptation software layer throws an exception. The exception can then be caught at the application layer, at which point the appropriate object instance destructors can be invoked, and code can be executed for cleaning up any resources dynamically allocated by the thread, clearing any software locks held by the thread, and performing any other desired commands specified by the programmer.

Alternatively, in some other embodiments of the present invention, the operating system itself might be modified to check for aborted threads at system calls, or scheduler operations, or within signal handlers, and throw an exception accordingly. While such alternative embodiments obviate the need for a separate, additional software layer and can provide an even greater degree of robustness, they have the disadvantage of requiring changes to the operating system source code, which in some cases might not be desirable, and in other cases might be impossible because the source code is inaccessible.

The illustrative embodiment comprises: intercepting a call to an operating system from an object-oriented program; detecting that a thread of said object-oriented program has been instructed to abort; throwing an exception in response to the detection; catching said exception; and invoking the destructor of said thread.

### BRIEF DESCRIPTION OF THE DRAWINGS

FIG. 1 depicts illustrative code of an object-oriented thread for launching a missile, in accordance with the prior art.

FIG. 2 depicts a block diagram of a layered object-oriented software framework that is capable of handling aborted threads gracefully, in accordance with the illustrative embodiment of the present invention.

FIG. 3 depicts illustrative code for object-oriented thread 212-1, as shown in FIG. 2, for the launch of a missile, in accordance with the illustrative embodiment of the present invention.

FIG. 4 depicts illustrative code for platform adaptation layer 230, as shown in FIG. 2, in accordance with the illustrative embodiment of the present invention.

### DETAILED DESCRIPTION

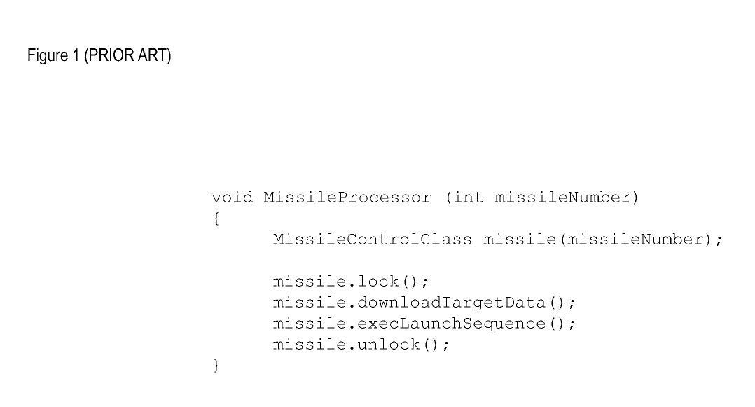

FIG. 1 depicts illustrative code of an object-oriented thread for launching a missile, in accordance with the prior art. At the first statement of thread MissileProcessor, an instance of class MissileControlClass called missile is created and instantiated. Subsequently, four methods of object missile are invoked sequentially [lock ( ), downloadTargetData ( ), execLaunchSequence ( ), and unlock ( )].

As will be appreciated by those skilled in the art, the code of FIG. 1 might be troublesome if a problem occurs during the execution of one of the four methods. For example, if a health monitor detects a problem during the execution of method downloadTargetData ( ), then it might abort the thread. However, because the thread is destroyed, the remaining two methods are never executed; consequently, the missile is never unlocked, and therefore remains unusable until the system is restarted. In addition, if method downloadTargetData ( ) has itself accessed a system resource (e.g., the file system, etc.), it might be left in an inconsistent state.

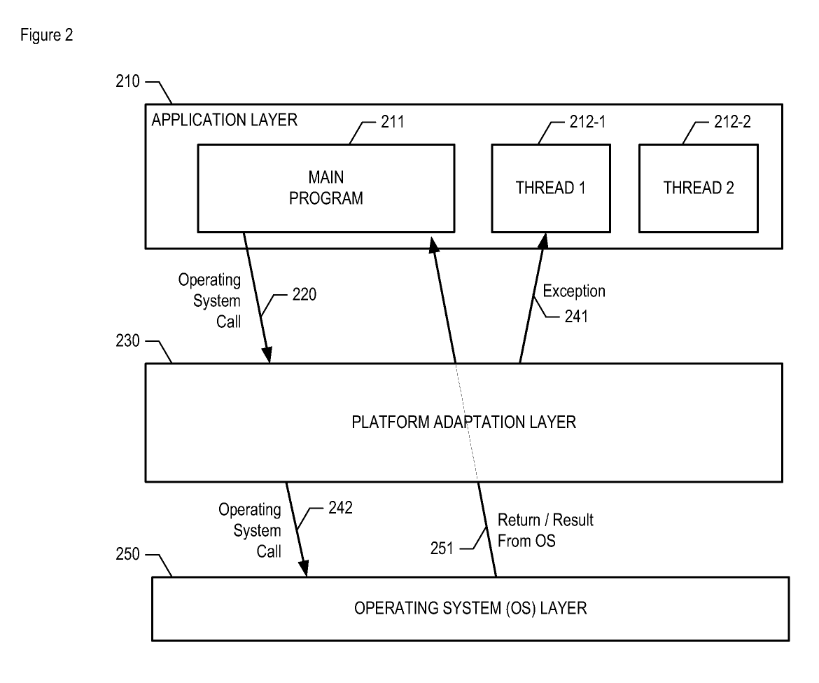

FIG. 2 depicts a block diagram of a layered object-oriented software framework that is capable of handling aborted threads gracefully, in accordance with the illustrative embodiment of the present invention. As shown in FIG. 2, the framework comprises application layer 210, platform adaptation layer 230, and operating system (OS) layer 250, interconnected by the transmission of the following signals between these layers: operating system (OS) call 220, exception 241, operating system (OS) call 242, and return/result 251 from OS layer 250.

Application layer 210 comprises main program 211 and threads 212-1 and 212-2.

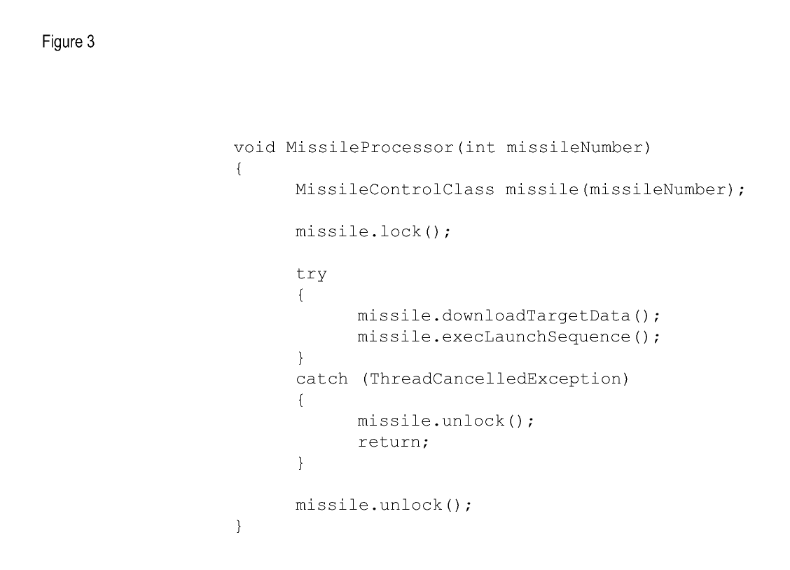

Main program 211 is a conventional object-oriented program, such as is found in a C++ main ( ) procedure. Illustrative code for main program 211 is described below and with respect to FIG. 3.

Threads 212-1 and 212-2 are spawned by main program 211 during its execution. Threads 212-1 and 212-2 comprise object-oriented code and are capable of being aborted due to one or more conditions or events (e.g., failure of a hardware resource, etc.), in well-known fashion, as well as catching and processing exceptions, as described below and with respect to FIG. 3. As will be appreciated by those skilled in the art, the fact that two threads happen to be depicted in FIG. 2 is merely illustrative, as the exact number of threads 212 will depend on the particular code of main program 211.

Platform adaptation layer 230 comprises one or more standard constructs of an object-oriented programming language (e.g., a C++ object instance, etc.) that are capable of: intercepting an operating system (OS) call from application layer 210 to operating system (OS) layer 250 (e.g., illustrative OS call 220, etc.); detecting when a thread has aborted; throwing an exception that indicates that a thread has aborted (e.g., illustrative exception 241, etc.); and subsequently allowing an intercepted operating system (OS) call from application layer 210 to be received by operating system (OS) layer 250 (e.g., illustrative OS call 242, etc.). In accordance with the illustrative embodiment, the detection of the aborting of a thread is platform-dependent; however, as will be appreciated by those skilled in the art, in some other embodiments of the present invention this detection might be specified in a platform-independent manner (e.g., via a Java object instance, etc.). In any case, it will be clear to those skilled in the art, after reading this disclosure, how to make and use embodiments of platform adaptation layer 230.

Operating system (OS) layer 250 comprises software that is capable of performing functions such as memory management, process scheduling, file system management, and so forth, as is well-known in the art. Operating system (OS) layer 250 is also capable of receiving system calls that originate from application layer 210 and are for performing one or more of these functions. Moreover, operating system layer 250 is capable of transmitting a return confirmation, or a result value, or both, to application layer 210 (e.g., return/result 251, etc.) in response to a system call.

FIG. 3 depicts illustrative code of object-oriented thread 212-1 for the launch of a missile, in accordance with the illustrative embodiment of the present invention. The code of FIG. 3 is a modified version of the code of FIG. 1, and comprises additional program statements that enable it to gracefully handle the aborting of the thread, as described below.

At the first statement of thread MissileProcessor, an instance of class MissileControlClass called missile is created and instantiated, just as in the prior art. At the second statement, method lock ( ) of instance missile is invoked, which is also the same as the code of FIG. 1 of the prior art. Subsequently, there is a try-catch block, in which methods downloadTargetData ( ) and then execLaunchSequence ( ) of instance missile are invoked in the try portion of the block, and method unlock ( ) of instance missile is invoked in the catch portion of the block.

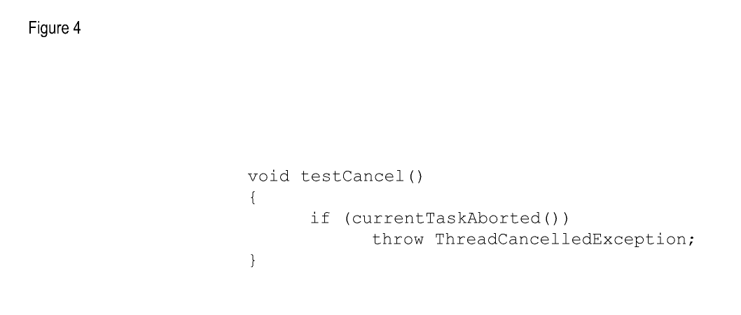

As is described below and with respect to FIG. 4, in accordance with the illustrative embodiment, an instance of class ThreadCancelledException is thrown when a thread is aborted. Consequently, if a problem occurs during the execution of method downloadTargetData ( ) that causes the thread to abort, then method execLaunchSequence ( ) is never executed, and the catch block will catch the corresponding ThreadCancelledException and invoke method unlock ( ) of instance missile. The return command that is executed after method unlock ( ) results in a normal exit from the thread's code and termination of the thread. As part of the normal thread termination, the destructor of object instance missile is invoked, thereby freeing its resources.

In accordance with the illustrative embodiment, the exception handling illustrated in thread MissileProcessor is employed similarly throughout the code. For example, the code for method downloadTargetData ( ) will also have this type of exception handling, so that if the thread is aborted during execution of this method, the file system can be left in a consistent state.

FIG. 4 depicts illustrative code for platform adaptation layer 230, in accordance with the illustrative embodiment of the present invention. In particular, FIG. 4 depicts the code for a method testCancel ( ) that is invoked whenever an operating system (OS) call from application layer 210 is intercepted, as described above.

The first statement of testCancel ( ) invokes a predicate method currentTaskAborted ( ) that returns true if and only if it detects that the current task, and thus its associated thread, has been aborted. As described above, in accordance with the illustrative embodiment the detection performed by method currentTaskAborted ( ) is platform-dependent; however, as will be appreciated by those skilled in the art, in some other embodiments of the present invention this detection might be specified in a platform-independent manner.

If method currentTaskAborted ( ) returns true, then an instance of ThreadCancelledException is thrown; this exception then can be caught and handled by the thread via standard programming, as described above and with respect to FIG. 3. If method currentTaskAborted ( ) returns false, then method testCancel ( ) does nothing. After method testCancel ( ) has completed, platform adaptation layer 230 allows the intercepted operating system (OS) call that triggered the execution of testCancel ( ) to reach OS layer 250, in well-known fashion.

As described above, in some other embodiments of the present invention, the operating system itself might check for aborted threads at each system call, and accordingly throw exceptions, instead of having these functions performed by a separate software layer (e.g., platform adaptation layer 230 of the illustrative embodiment, etc.). Such alternative embodiments might be capable of providing even greater robustness than the illustrative embodiment; however, they require access to the operating system source code.

It is to be understood that the disclosure teaches just one example of the illustrative embodiment and that many variations of the invention can easily be devised by those skilled in the art after reading this disclosure and that the scope of the present invention is to be determined by the following claims.

What is claimed is:

1. A method comprising:
intercepting a call to an operating system from an object-oriented program;
detecting that a thread of said object-oriented program has been instructed to abort;
throwing an exception in response to the detection;
catching said exception; and
invoking the destructor of said thread.

2. The method of claim 1 further comprising cleaning up any resources allocated by said thread, prior to the invocation of said destructor.

3. The method of claim 1 further comprising executing one or more additional programmer-specified commands, prior to the invocation of said destructor.

4. The method of claim 1 wherein said method is performed exclusively by one or more object instances of said object-oriented program.

5. The method of claim 1 wherein said object-oriented program is a C++ program.

6. The method of claim 5 wherein said method is performed exclusively via one or more standard constructs of an object-oriented programming language.

7. The method of claim 1 wherein the interception of said call and the detection is platform-dependent, and wherein the remainder of said method is platform-independent.

8. A method comprising:
intercepting a call to an operating system from an object-oriented program;
detecting that a thread of said object-oriented program has been instructed to abort;
throwing an exception in response to the detection;
catching said exception; and
cleaning up any resources allocated by said thread, after the catching of said exception.

9. The method of claim 8 further comprising releasing any software locks held by said thread, after the catching of said exception.

10. The method of claim 8 further comprising executing one or more additional programmer-specified commands, after the catching of said exception.

11. The method of claim 8 wherein said method is performed exclusively by one or more object instances of said object-oriented program.

12. The method of claim 8 wherein said object-oriented program is a C++ program.

13. The method of claim 12 wherein said method is performed exclusively via one or more standard constructs of an object-oriented programming language.

14. The method of claim 8 wherein the interception of said call and the detection is platform-dependent, and wherein the remainder of said method is platform-independent.

15. A method of terminating an aborted thread of an object-oriented program using only standard constructs of an object-oriented programming language, said method comprising:
detecting that a thread of said object-oriented program has been instructed to abort; and
terminating said thread.

16. The method of claim 15 further comprising cleaning up any resources allocated by said thread, prior to the invocation of said destructor.

17. The method of claim 15 further comprising releasing any software locks held by said thread, prior to the invocation of said destructor.

18. The method of claim 15 further comprising executing one or more additional programmer-specified commands, prior to the invocation of said destructor.

19. The method of claim 15 wherein the detection is platform-dependent.

20. The method of claim 15 wherein said object-oriented program is a C++ program.
